(19) United States
(12) Patent Application Publication
(10) Pub. No.: US 2024/0316673 A1
(43) Pub. Date: Sep. 26, 2024

(54) WELDING POWER SUPPLIES AND METHODS TO CONTROL OVERLAPPING SPOT WELDS

(71) Applicant: Illinois Tool Works Inc., Glenview, IL (US)

(72) Inventors: Craig Steven Knoener, Appleton, WI (US); Samuel Paul Gill, Seymour, WI (US)

(21) Appl. No.: 18/610,471

(22) Filed: Mar. 20, 2024

Related U.S. Application Data
(60) Provisional application No. 63/492,060, filed on Mar. 24, 2023.

(51) Int. Cl. B23K 9/10

(52) U.S. Cl. CPC B23K 9/1043

(57) ABSTRACT

Disclosed example welding power supplies include: power conversion circuitry configured to convert input power to welding power; and control circuitry configured to: set a spot timer representative of an arc duration for a plurality of sequential arc welds; set a stitch timer representative of a duration between sequential ones of the sequential arc welds; and in response to initiation of welding, controlling the power conversion circuitry to perform the plurality of sequential arc welds by controlling the arc duration of each of the plurality of sequential arc welds based on the spot timer and controlling the duration between the sequential ones of the sequential arc welds based on the stitch timer, wherein the spot timer and the stitch timer are set to cause sequential ones of the sequential arc welds to overlap.

### RELATED APPLICATIONS

The present application claims the benefit of U.S. Provisional Patent Application Ser. No. 63/492,060, filed Mar. 24, 2023, entitled “welding power supplies and methods to control overlapping spot welds.” The entirety of U.S. Provisional Patent Application Ser. No. 63/492,060 is expressly incorporated herein by reference.

### FIELD OF THE DISCLOSURE

This disclosure relates generally to welding and, more particularly, to welding power supplies and methods to control overlapping spot welds.

### BACKGROUND

Welding of thin metal can often result in burning through the metal. Burning through the workpiece can be caused in whole or in part by excess current, insufficiently high travel speed, poor weld fit up (e.g., a gap between two pieces of metal), insufficient thickness in the location of the weld (e.g., from excessive grinding to prepare for the weld), improper travel angle (e.g., too steep), improper weld settings (e.g., too much heat), and/or poor weld control loops in the welding power supply (e.g., the power supply does not properly control the delivery of energy in a short circuit transfer).

### SUMMARY

Welding power supplies and methods to control overlapping spot welds are disclosed, substantially as illustrated by and described in connection with at least one of the figures, as set forth more completely in the claims.

### BRIEF DESCRIPTION OF THE DRAWINGS

FIG. 1 is a block diagram of an example welding system including a remote wire feeder and configured to provide power control, in accordance with aspects of this disclosure.

FIG. 2 is a block diagram of another example welding system configured to provide power control with a welding-type power supply having an integrated wire feeder, in accordance with aspects of this disclosure.

FIG. 3 illustrates an example welding output power waveform that may be output by the welding systems of FIGS. 1 and/or 2 during a sequence of welds controlled using a spot timer and a stitch timer.

FIG. 4 illustrates an example wire feed speed and an example output voltage during an example one of the sequential welds of FIG. 3.

FIG. 5 illustrates an example output voltage and an example output current during a ball elimination burnback process of an example one of the sequential welds of FIG. 3.

FIGS. 6A and 6B are a flowchart representative of example machine readable instructions which may be executed by the control circuitry of FIGS. 1 and/or 2 to control a welding process including sequential overlapping welds.

FIG. 7 is flowchart representative of example machine readable instructions which may be executed by the control circuitry of FIGS. 1 and/or 2 to perform a crater fill process.

FIG. 8 is flowchart representative of example machine readable instructions which may be executed by the control circuitry of FIGS. 1 and/or 2 to perform a ball elimination burnback process.

The figures are not necessarily to scale. Where appropriate, similar or identical reference numbers are used to refer to similar or identical components.

### DETAILED DESCRIPTION

Conventional techniques to avoid burn-through include making a series of short, separate welds instead of a long continuous weld. While welding, the welder is transferring heat into the work piece, and between welds the workpiece is transferring heat to the surrounding environment. The combination of the small welds and the time between welds reduces the likelihood of burn-through. Additionally, the pattern of the welds may be such that welds are staggered over the length of the joint.

Another conventional technique to avoid burn-through is to make a series of overlapping spot welds. However, this conventional technique results in significantly more spatter than a continuous weld for the same joint, and each overlapping tack weld can result in a crater. Furthermore, the repetitive pressing and releasing of the trigger to perform the overlapping spot welds can result in excess strain on the operator and/or inaccuracy of the weld location.

Disclosed example power supplies and methods provide an easier and more consistent welding process to weld while reducing the likelihood of burn-through. In some examples, a spot timer and a stitch timer are used to control the formation of a sequence of multiple welds, including the duration of each weld and the time between the welds, such that sequential welds overlap. The value of the spot timer determines the duration of each weld, and the value of the stitch timer is the length of time between welds. Disclosed example power supplies and methods may assist the operator in selecting appropriate values for the spot timer and the stitch timer based on characteristics of the weld, such as the material thickness, welding wire diameter, welding wire type, and/or travel speed.

In disclosed examples, the operator may initiate welding (e.g., by depressing a trigger), and perform a sequence of welds while the welding is ongoing, without having to repeatedly initiate and end the welding as with conventional repetitive spot welding. While the result of the sequence of welds may be similar to discrete overlapping spot welds, disclosed example power supplies and methods improve the uniformity, speed, and overall appearance of the weld, compared with conventional techniques. In some examples, the power supply may adjust the beginning of individual welds, the end of individual welds, the beginning of the sequence of welds, and/or the end of the sequence of welds, to further improve the results of the sequence of overlapping welds. For example, adjustments may reduce craters, reduce spatter, improve uniformity of the welds, and/or improve the welding parameters to further reduce the potential for burn-through.

In an example of operation, a welding operator selects the weld parameters and activates the sequential welding mode. The operator may then initiate welding (e.g., by depressing and holding the trigger), and hold the welding torch in a fixed location during the spot time for each weld, as controlled by the spot timer. Once a weld terminates at the expiration of the spot timer, the operator moves the torch to a next location, such as an edge of the last weld, and waits for the next weld to start, as controlled by the stitch timer. The cycle of fixed location and movement is repeated until the operator releases the trigger to end the sequence of welds.

As used herein, the term “welding-type power” refers to power suitable for welding, plasma cutting, induction heating, CAC-A and/or hot wire welding/preheating (including laser welding and laser cladding). As used herein, the term “welding-type power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, a “welding-type power supply” refers to any device capable of, when power is applied thereto, supplying welding, cladding, plasma cutting, induction heating, laser (including laser welding, laser hybrid, and laser cladding), carbon arc cutting or gouging and/or resistive preheating, including but not limited to transformer-rectifiers, inverters, converters, resonant power supplies, quasi-resonant power supplies, switch-mode power supplies, etc., as well as control circuitry and other ancillary circuitry associated therewith.

As used herein, a “weld voltage setpoint” refers to a voltage input to the power converter via a user interface, network communication, weld procedure specification, or other selection method.

As used herein, a “circuit” includes any analog and/or digital components, power and/or control elements, such as a microprocessor, digital signal processor (DSP), software, and the like, discrete and/or integrated components, or portions and/or combinations thereof.

As used herein, the term “remote wire feeder” refers to a wire feeder that is not integrated with the power supply in a single housing.

Disclosed example welding power supplies include: power conversion circuitry configured to convert input power to welding power; and control circuitry configured to: set a spot timer representative of an arc duration for a plurality of sequential arc welds; set a stitch timer representative of a duration between sequential ones of the sequential arc welds; and in response to initiation of welding, controlling the power conversion circuitry to perform the plurality of sequential arc welds by controlling the arc duration of each of the plurality of sequential arc welds based on the spot timer and controlling the duration between the sequential ones of the sequential arc welds based on the stitch timer, wherein the spot timer and the stitch timer are set to cause sequential ones of the sequential arc welds to overlap.

In some example welding power supplies, the spot timer is based on at least one of a material thickness input, a wire diameter input, a wire type input, or a shielding gas type input. In some example welding power supplies, the stitch timer is based on at least one of a material thickness input, a wire diameter input, a wire type input, or a shielding gas type input. In some example welding power supplies, the spot timer is less than 1 second and/or the stitch timer is less than 2 seconds.

In some example welding power supplies, the control circuitry is configured to, following initiation of an arc, ramp at least one of a wire feed speed or a voltage from an initial value up to a setpoint value. In some example welding power supplies, the control circuitry is configured to, following expiration of the spot timer, ramp down the wire feed speed for a predetermined crater fill time. In some example welding power supplies, the control circuitry is configured to, in response to detecting a clearing of a short circuit, control the power conversion circuitry to step down the current.

In some example welding power supplies, the control circuitry is configured to, in response to detecting an end of an arc during the plurality of sequential welds: control the power conversion circuitry to increase an output current until a short circuit clear is detected; and in response to detecting the short circuit clear, control the power conversion circuitry to reduce the output current to less than a threshold current at at least a threshold ramp rate. In some example welding power supplies, the control circuitry is configured to, in response to the initiation of welding: for at least one of a predetermined number of the sequential welds or a predetermined time, increase an output power relative to an output power based on setpoints; and decreasing the output power for each sequential one of the plurality of welds until reaching the output power based on the setpoints.

Some example welding power supplies further include a user interface configured to receive at least one of a material thickness input, a wire diameter input, a wire type input, or a shielding gas type input, and comprising an input configured to turn the spot timer and the stitch timer on or off. In some example welding power supplies, the user interface is configured to receive an input modifying a travel speed, and the control circuitry is configured to set at least one of the spot timer or the stitch timer based on the modified travel speed. In some example welding power supplies, the user interface is configured to receive at least one of an input to modify the spot timer or an input to modify the stitch timer. In some example welding power supplies, the control circuitry is configured to, in response to the input turning on the at least one of the spot timer or the stitch timer, modify at least one of a parameter to increase the heat input or a control loop response rate.

In some example welding power supplies, the control circuitry is configured to continue controlling the power conversion circuitry to perform the plurality of sequential welds while a welding torch trigger remains actuated. In some example welding power supplies, at least one of the spot timer or the stitch timer are based on a travel speed input. In some example welding power supplies, at least one of the spot timer or the stitch timer are based on a same travel speed as a continuous weld for a same material thickness, a same wire diameter, a same wire type, and a same shielding gas type input.

Some example welding power supplies further include a weld position sensor configured to determine a travel speed of a welding torch, the control circuitry configured to set at least one of the spot timer or the stitch timer based on the determined travel speed. In some example welding power supplies, at least one of the spot timer or the travel timer are fixed for the entirety of the plurality of sequential welds. In some example welding power supplies, at least one of the spot timer or the stitch timer are ramped over a predetermined number of the sequential welds following the initiation of welding.

Other disclosed example welding power supplies include: power conversion circuitry configured to convert input power to welding power; weld torch positioning sensor configured to determine a position of the weld torch; and control circuitry configured to: set a spot timer representative of an arc duration for a plurality of sequential arc welds; in response to initiation of welding, controlling the power conversion circuitry to perform the plurality of sequential arc welds by: controlling a beginning of each of the sequential arc welds based on the position of the weld torch; and controlling the arc duration of each of the plurality of sequential arc welds based on the spot timer.

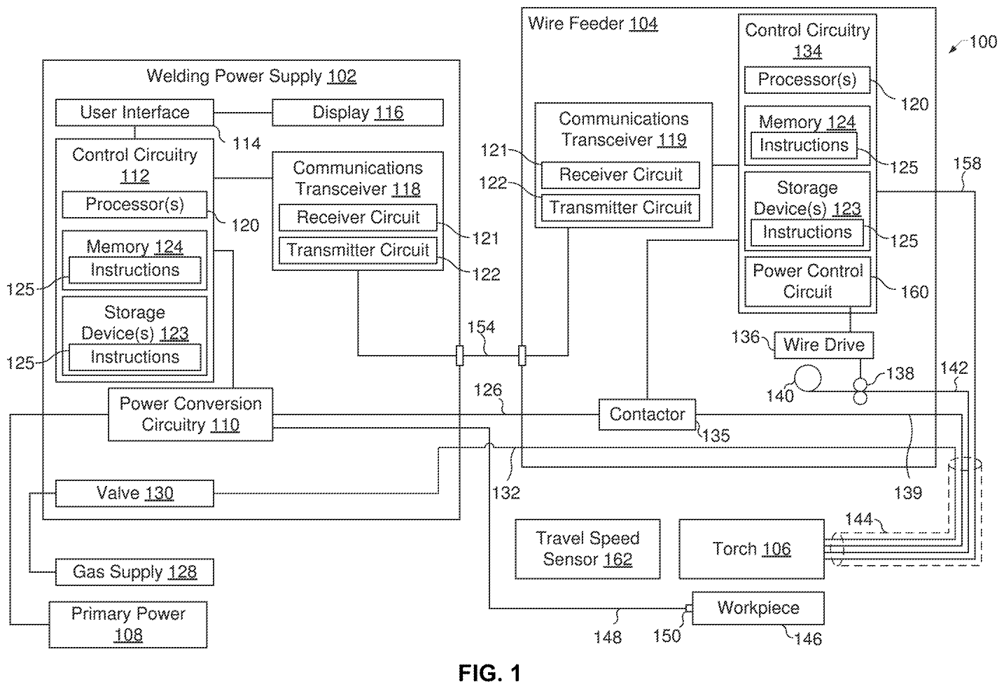

Turning now to the drawings, FIG. 1 is a block diagram of an example welding system 100 having a welding power supply 102, a wire feeder 104, and a welding torch 106. The welding system 100 powers, controls, and supplies consumables to a welding application. The example welding torch 106 is configured for gas metal arc welding (GMAW). In the illustrated example, the power supply 102 is configured to supply power to the wire feeder 104, and the wire feeder 104 may be configured to route the input power to the welding torch 106. In addition to supplying an input power, the wire feeder 104 supplies a filler metal to a welding torch 106 for various welding applications (e.g., GMAW welding, flux core arc welding (FCAW).

The power supply 102 receives primary power 108 (e.g., from the AC power grid, an engine/generator set, a battery, or other energy generating or storage devices, or a combination thereof), conditions the primary power, and provides an output power to one or more welding devices in accordance with demands of the system 100. The primary power 108 may be supplied from an offsite location (e.g., the primary power may originate from the power grid). The power supply 102 includes a power conversion circuitry 110, which may include transformers, rectifiers, switches, and so forth, capable of converting the AC input power to AC and/or DC output power as dictated by the demands of the system 100 (e.g., particular welding processes and regimes). The power conversion circuitry 110 converts input power (e.g., the primary power 108) to welding-type power based on a weld voltage setpoint and outputs the welding-type power via a weld circuit.

In some examples, the power conversion circuitry 110 is configured to convert the primary power 108 to both welding-type power and auxiliary power outputs. However, in other examples, the power conversion circuitry 110 is adapted to convert primary power only to a weld power output, and a separate auxiliary converter is provided to convert primary power to auxiliary power. In some other examples, the power supply 102 receives a converted auxiliary power output directly from a wall outlet. Any suitable power conversion system or mechanism may be employed by the power supply 102 to generate and supply both weld and auxiliary power.

The power supply 102 includes control circuitry 112 to control the operation of the power supply 102. The power supply 102 also includes a user interface 114. The control circuitry 112 receives input from the user interface 114, through which a user may choose a process and/or input desired parameters (e.g., voltages, currents, particular pulsed or non-pulsed welding regimes, and so forth). The user interface 114 may receive inputs using any input device, such as via a keypad, keyboard, buttons, touch screen, voice activation system, wireless device, etc. Furthermore, the control circuitry 112 controls operating parameters based on input by the user as well as based on other current operating parameters. Specifically, the user interface 114 may include a display 116 for presenting, showing, or indicating, information to an operator. The control circuitry 112 may also include interface circuitry for communicating data to other devices in the system 100, such as the wire feeder 104. For example, in some situations, the power supply 102 wirelessly communicates with the wire feeder 104 and/or other welding devices within the welding system 100. Further, in some situations, the power supply 102 communicates with the wire feeder 104 and/or other welding devices using a wired connection, such as by using a network interface controller (NIC) to communicate data via a network (e.g., ETHERNET, 10BASE2, 10BASE-T, 100BASE-TX, etc.).

The control circuitry 112 includes at least one processor 120 that controls the operations of the power supply 102. The control circuitry 112 receives and processes multiple inputs associated with the performance and demands of the system 100. The processor 120 may include one or more microprocessors, such as one or more “general-purpose” microprocessors, one or more special-purpose microprocessors and/or ASICS, and/or any other type of processing device and/or logic circuit. For example, the processor 120 may include one or more digital signal processors (DSPs).

The example control circuitry 112 includes one or more storage device(s) 123 and one or more memory device(s) 124. The storage device(s) 123 (e.g., nonvolatile storage) may include ROM, flash memory, a hard drive, and/or any other suitable optical, magnetic, and/or solid-state storage medium, and/or a combination thereof. The storage device 123 stores data (e.g., data corresponding to a welding application), instructions (e.g., software or firmware to perform welding processes), and/or any other appropriate data. Examples of stored data for a welding application include an attitude (e.g., orientation) of a welding torch, a distance between the contact tip and a workpiece, a voltage, a current, welding device settings, and so forth.

The memory device 124 may include a volatile memory, such as random access memory (RAM), and/or a nonvolatile memory, such as read-only memory (ROM). The memory device 124 and/or the storage device(s) 123 may store a variety of information and may be used for various purposes. For example, the memory device 124 and/or the storage device(s) 123 may store processor executable instructions 125 (e.g., firmware or software) for the processor 120 to execute. In addition, one or more control regimes for various welding processes, along with associated settings and parameters, may be stored in the storage device 123 and/or memory device 124, along with code configured to provide a specific output (e.g., initiate wire feed, enable gas flow, capture welding current data, detect short circuit parameters, determine amount of spatter) during operation.

In some examples, the welding power flows from the power conversion circuitry 110 through a weld cable 126 to the wire feeder 104 and the welding torch 106. The example weld cable 126 is attachable and detachable from weld studs at each of the power supply 102 and the wire feeder 104 (e.g., to enable case of replacement of the weld cable 126 in case of wear or damage).

The example communications transceiver 118 includes a receiver circuit 121 and a transmitter circuit 122. Generally, the receiver circuit 121 receives data transmitted by the wire feeder 104 and the transmitter circuit 122 transmits data to the wire feeder 104. The example wire feeder 104 also includes a communications transceiver 119, which may be similar or identical in construction and/or function as the communications transceiver 118.

In some examples, a gas supply 128 provides shielding gases, such as argon, helium, carbon dioxide, and so forth, depending upon the welding application. The shielding gas flows to a valve 130, which controls the flow of gas, and if desired, may be selected to allow for modulating or regulating the amount of gas supplied to a welding application. The valve 130 may be opened, closed, or otherwise operated by the control circuitry 112 to enable, inhibit, or control gas flow (e.g., shielding gas) through the valve 130. Shielding gas exits the valve 130 and flows through a gas conduit 132 (which in some implementations may be packaged with the welding power output) to the wire feeder 104 which provides the shielding gas to the welding application. In some examples, the welding system 100 does not include the gas supply 128, the valve 130, and/or the gas conduit 132. In some other examples, the valve 130 is located in the wire feeder 104, and, the gas supply 128 is connected to the wire feeder 104.

In some examples, the wire feeder 104 uses the welding power to power the various components in the wire feeder 104, such as to power wire feeder control circuitry 134. As noted above, the weld cable 126 may be configured to provide or supply the welding power. The wire feeder control circuitry 134 controls the operations of the wire feeder 104. In some examples, the wire feeder 104 uses the wire feeder control circuitry 134 to detect whether the wire feeder 104 is in communication with the power supply 102 and to detect a current welding process of the power supply 102 if the wire feeder 104 is in communication with the power supply 102.

A contactor 135 (e.g., high amperage relay) is controlled by the wire feeder control circuitry 134 and configured to enable or inhibit welding power to continue to flow to a weld conductor 139 from the weld cable 126 for the welding application. In some examples, the contactor 135 is an electromechanical device. However, the contactor 135 may be any other suitable device, such as a solid-state device, and/or may be omitted entirely and the weld cable 126 is directly connected to the output to the welding torch 106. The wire feeder 104 includes a wire drive 136 that receives control signals from the wire feeder control circuitry 134 to drive rollers 138 that rotate to pull wire off a spool 140 of wire. The wire drive 136 feeds electrode wire to the welding torch 106. The wire is provided to the welding application through a wire liner 142. Likewise, the wire feeder 104 may provide the shielding gas from the gas conduit 132. The example gas conduit 132, the example wire liner 142, and the example conductor 139 are combined in a torch cable 144 and/or individually provided to the welding torch 106.

The welding torch 106 delivers the wire, welding power, and/or shielding gas for a welding application. The welding torch 106 is used to establish a welding arc between the welding torch 106 and a workpiece 146. A work cable 148 couples the workpiece 146 to the power supply 102 (e.g., to the power conversion circuitry 110) to provide a return path for the weld current (e.g., as part of the weld circuit). The example work cable 148 is attachable and/or detachable from the power supply 102 for case of replacement of the work cable 148. The work cable 148 may be terminated with a clamp 150 (or another power connecting device), which couples the power supply 102 to the workpiece 146.

A communication cable 154 connected between the power supply 102 and the wire feeder 104, which enables bidirectional communication between the transceivers 118, 119. The communications transceivers 118 and 119 may communicate via the communication cable 154, via the weld circuit, via wireless communications, and/or any other communication medium. Examples of such communications include weld cable voltage measured at a device that is remote from the power supply 102 (e.g., the wire feeder 104).

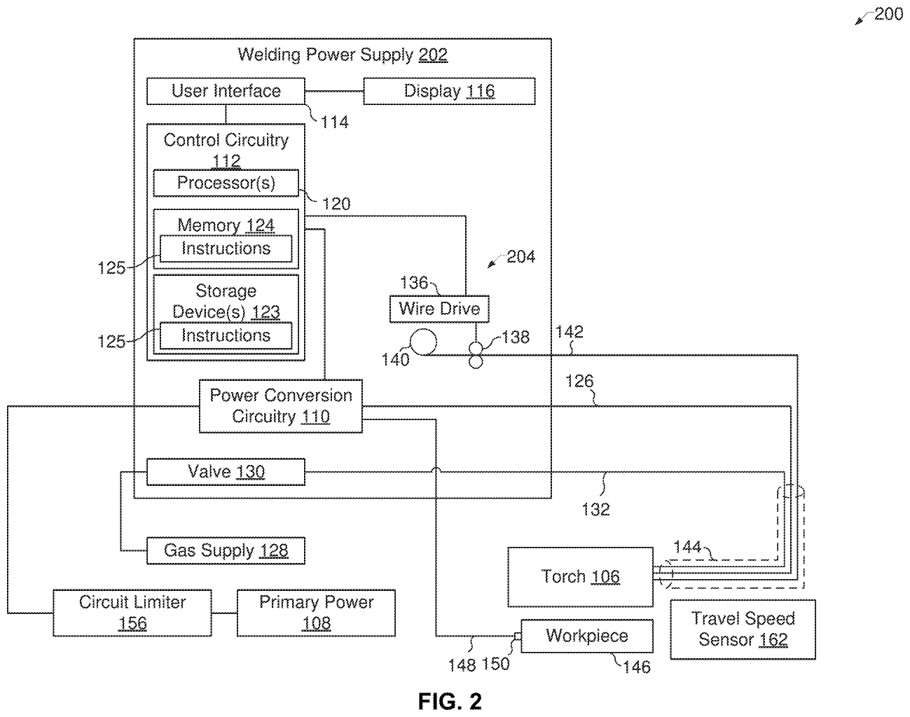

FIG. 2 is a block diagram of another example welding-type system 200 configured to provide power control with a welding power supply 202 having an integrated wire feeder 204. The example welding power supply 202 includes the power conversion circuitry 110, control circuitry 112, the user interface 114, the display 116, the processor(s) 120, the storage devices(s) 123, the memory 124, the instructions 125, and the valve 130 of the example power supply 102 of FIG. 1.

In contrast with the example system 100, in the example of FIG. 2 the power supply 202 includes the integrated wire feeder 204 instead being connected to a remote wire feeder. The power supply 202 of FIG. 2 outputs welding-type power and electrode wire to the torch 106.

The integrated wire feeder 204 includes the wire drive 136, the drive rollers 138, and the wire spool 140, and feeds the wire through a torch cable 144 to the torch 106.

In some examples, the system 100 may be provided with a weld position sensor 162, which communicates with the power supply 102 via wired and/or wireless communications. Example implementations of the weld position sensor 162 are disclosed in U.S. Pat. No. 9,573,215 to Pfeifer et al., U.S. Pat. No. 10,335,883 to Albrecht et al., U.S. Pat. No. 11,090,753 to Luo et al., and U.S. Pat. No. 11,423,800 to Batzler et al. The entireties of U.S. Pat. Nos. 9,573,215, 10,335,883, 11,090,753, and 11,423,800 are incorporated herein by reference. As disclosed in more detail below, the control circuitry 112 may adjust welding parameters, timers, and/or other aspects of welding based on the sensed travel speed.

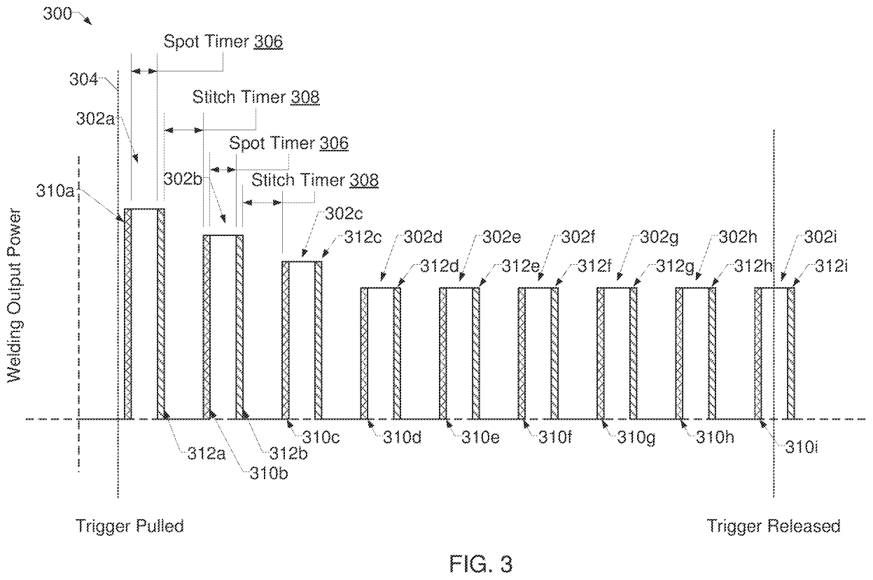

FIG. 3 illustrates an example welding output power waveform 300 that may be output by the welding power supplies 102, 202 of FIGS. 1 and/or 2 during a sequence of welds 302a-302i controlled using a spot timer 306 and a stitch timer 308. The spot timer 306 and/or the stitch timer 308 may be implemented by the control circuitry 112 and/or by other circuitry in the power supply 102, 202 (e.g., as a register, a dedicated timer, a general purpose timer, etc.).

The control circuitry 112 may set values for the spot timer 306 and/or the stitch timer 308 based on parameters or characteristics of the weld. For example, the spot timer 306 and/or the stitch timer 308 may be set based on material thickness, wire diameter, wire type, shielding gas type, travel speed, and/or any other parameters. The weld parameter or characteristic values may be obtained via the user interface 114 or other source of user input to the power supply 102.

The example waveform 300 is initialized at a first time 304 in response to an initiation of welding (e.g., by depressing the trigger, depressing a foot pedal, etc.). The control circuitry 112 controls the power conversion circuitry 110 to output welding power (e.g., voltage and current), and may control a wire feeder to feed welding wire to the torch 106. The duration of each weld 302a-302i is determined by the spot timer 306. For example, the spot timer is run from the beginning of each weld 302a-302i and the control circuitry 112 controls the power conversion circuitry 110 to end the weld 302a-302i in response to expiration of the spot timer 306. Conversely, the stitch timer 308 is run from the end of each weld 302a-302i, and the control circuitry 112 controls the power conversion circuitry 110 to begin a next weld 302a-302i in response to expiration of the stitch timer 308 (provided the trigger is still activated).

The spot timer 306 and the stitch timer 308 are each set to a determined value, and count down in accordance with a clock to an end value (e.g., zero). When the running spot timer 306 or stitch timer 308 reaches the end value, that counter is considered to be completed or ended, and may trigger a subsequent event as disclosed herein. In other examples, the spot timer 306 and/or the stitch timer 308 may count up from the determined start value to the end value. When the spot timer 306 and the stitch timer 308 reach the end value, the counter is reset to the respective determined value prior to the next use or execution of that timer. For example, when the spot timer 306 is completed, the control circuitry 112 resets the value of the spot timer 306 to the determined starting value for timing the duration of the next weld 302a-302i.

The values of the spot timer 306 and/or the stitch timer 308 may be fixed for the duration of the welds 302 or the spot timer 306 and/or the stitch timer 308 may be dynamically adjusted based on a sensed position of the welding torch 106 (e.g., using a weld position sensor 162). For example, the control circuitry 112 may adjust the spot timer 306 and/or the stitch timer 308 based on the average travel speed and/or the detected position of the torch 106. Additionally or alternatively, the control circuitry 112 may trigger each weld 302 based on detecting that the torch 106 is in the correct position to begin the next weld. By using the detected travel speed, the overlap distances between sequential welds 302 are more consistent and/or the weld appearance is improved.

In still other examples, the spot timer 306 and/or the stitch timer 308 may be based on a target spot size and/or a target movement distance between spots. For example, the spot timer 306 may be selected to obtain a target spot size, and the amount of movement between spots is based on the spot size (e.g., a subsequent weld is started at an outer edge of the prior weld spot).

The example user interface 114 may allow the operator to adjust the spot timer 306 and/or the stitch timer 308. For example, the operator may input changes to value(s) for the spot timer 306 and/or the stitch timer 308 to allow for a faster or slower travel speed. The example control circuitry 112 may adjust other parameters or variables of the power supply 102 and/or the wire feeder 104 to perform the sequence of welds 302, relative to the values of such parameters or variables for conventional welding or conventional tack welding. For example, the control circuitry 112 may specify one or more control loop response rates (e.g., arc response rates, current and/or voltage ramp response rates, etc.) and/or increase the heat input for the sequence of welds 302.

Each of the example welds 302a-302i may include a run-in period 310a-310i and/or a post-weld period 312a-312i.

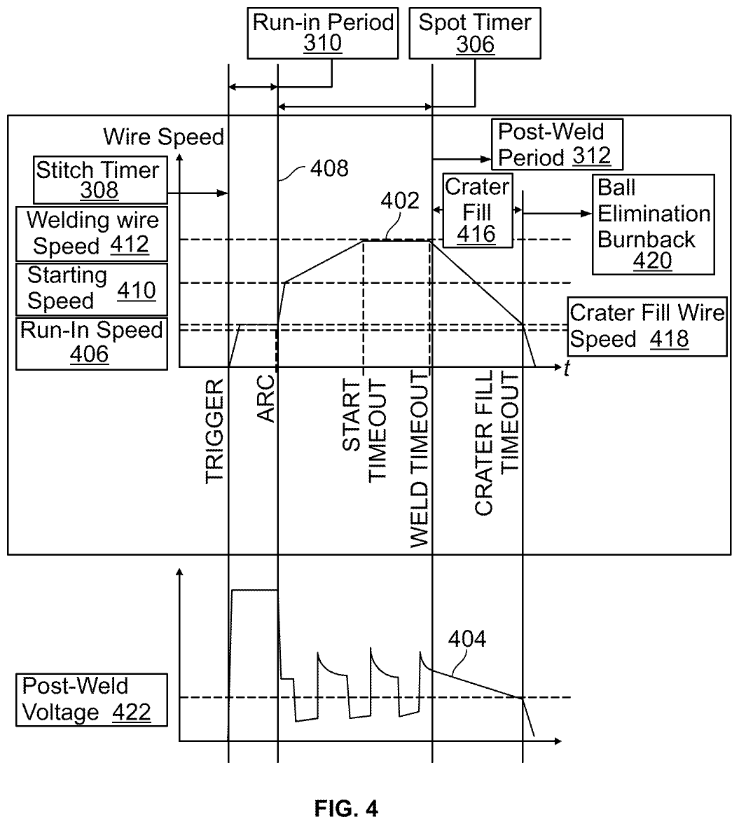

FIG. 4 illustrates an example wire feed speed 402 and an example output voltage 404 during an example one of the sequential welds 302a-302i of FIG. 3. The end of the stitch timer 308 triggers the run-in period 310. When the run-in period 310 begins, the control circuitry 112 controls the wire feeder to begin feeding the welding wire and controls the power conversion circuitry 110 to output welding power. The wire feed speed 402 ramps up to a run-in speed 406 until an arc is struck at time 408. In response to striking the arc, the control circuitry 112 starts the spot timer 306 and controls the wire feeder to increase the wire feed speed 402 to a starting wire speed 410, and then to ramp to a welding wire speed 412. The welding wire speed 412 may correspond to a setpoint speed or other desired welding speed.

At the expiration of the spot timer 306, the control circuitry 112 controls the power conversion circuitry 110 and/or the wire feeder in the post-weld period 312. The example post-weld period 312 begins with the control circuitry 112 controlling the power conversion circuitry 110 ending the arc, such as by reducing the output voltage 404 to a post-weld voltage 414. To reduce or avoid the presence of a crater (e.g., a sunken or recessed portion in the weld bead), the control circuitry 112 controls the wire feeder to ramp down the wire feed speed 402 (e.g., instead of stepping down or stopping the wire feeder) during a crater fill process 416 of the post weld period 312. When the wire feed speed 402 reaches a crater fill wire speed threshold 418, the control circuitry 112 controls the wire feeder to stop feeding wire.

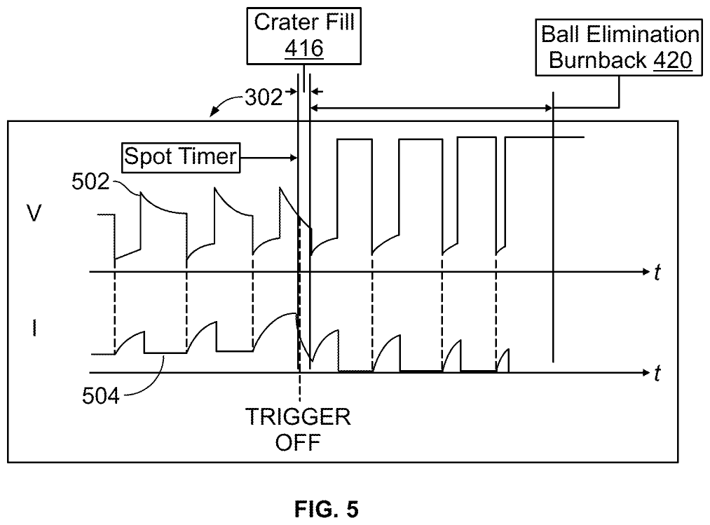

Following the crater fill process 416, the control circuitry 112 implements a ball elimination burnback process 420 to reduce or eliminate a size of a ball present on an end of the wire. Eliminating or reducing the size of the ball improves the arc starting and stability of the next weld 302 in the sequence. While the wire feeding has been controlled to stop, motor inertia, wire spool inertia, and/or inadvertent user movement can still result in contact between the wire tip and the workpiece, resulting in a short circuit that can stick the wire to the workpiece and/or cause a ball to form. FIG. 5 illustrates an example output voltage 502 and an example output current 504 during a ball elimination burnback process 420 of an example one of the sequential welds 302 of FIG. 3.

At an end of the crater fill process 416, the control circuitry 112 controls the power conversion circuitry 110 to reduce the output voltage 502. The reduced output voltage 502 is selected to be insufficient to sustain an arc (e.g., below 10 volts). During the burnback process 420, the control circuitry 112 controls the power conversion circuitry 110 to respond to detecting short circuits by increasing the current 504.

When the short circuit clears (e.g., when the output voltage 502 increases from below a short circuit threshold voltage to above the threshold voltage), the control circuitry 112 decreases the current 504 at at least a threshold ramp rate. In some examples, the control circuitry 112 decreases the current 504 in a step (e.g., controls the current to drop at a high rate, which may be controlled to be as fast as the control loop can decrease the current 504). The control circuitry 112 may decrease the current 504 to less than a threshold current, a minimum current, or other relatively low current value. For example, the current 504 may be set to a substantially minimum current as can be achieved while continuing to operate a switched mode power supply of the power conversion circuitry 110. However, any desired current may be selected.

The rapid decrease in the current 504 following the short circuits results in the reduction or elimination of a ball on the end of the welding wire. Additionally, when there is an open circuit between the wire and the workpiece, the output voltage 502 increases to an open circuit voltage. By reducing or avoiding the presence of a ball, the next arc start is more predictable and stable than if a larger ball was present at the end of the wire.

Additionally or alternatively, the control circuitry 112 may control the power conversion circuitry 110 to step down the current in response to short circuits that occur during a predetermined period following the run-in period 310, for a predetermined period prior to the expiration of the spot timer 306, and/or, if the spot timer 306 is sufficiently short, during the entirety of the weld 302 (e.g., while the spot timer 306 is running). If the spot timer 306 is longer than one or both predetermined periods, the control circuitry 112 may control the power conversion circuitry 110 to ramp down the current following short circuit clears. Similarly to the burnback process 420, stepping down the current during the arc provides a more consistent, reduced ball size at the end of the wire, and results in more consistent arc starting. Because the arc is being started repeatedly during the sequence of welds, a consistent arc starting state improves the resulting weld.

The control circuitry 112 may monitor an open circuit time during the ball elimination burnback process 420. When an open circuit is established for at least a threshold time (e.g., the short circuits are likely to be finished), the control circuitry 112 ends the ball elimination burnback process 420 and starts the stitch timer 208 to control the time between sequential welds.

While the foregoing examples are described with reference to short circuit transfers of the welding wire, the example sequence of welds 302 may be implemented using any desired transfer modes, including but not limited to controlled short circuit, short arc, globular, spray, and/or pulse welding. Additionally or alternatively, the wire may be preheated prior to delivery to the welding arc, further reducing the heat required by the arc to melt the wire. Example systems, welding torches, and/or conversion apparatus that may be used to preheat the welding wire is disclosed in U.S. Patent Publication No. 2020/0376597 to Hoeger et al. The entirety of U.S. Patent Publication No. 2020/0376597 is incorporated herein by reference.

Returning to FIG. 3, when initiating a sequence of overlapping welds, the temperature of the workpiece takes time to increase to a stable temperature. To compensate for the stabilization period (e.g., to compensate for a reduced temperature in the workpiece relative to later welds), during a predetermined number of the first welds 302a-302c in the waveform 300, the control circuitry 112 implements a hot-start power increase in the welding output power during the welds 302a-302c. As shown in FIG. 3, the hot-start power increase may decrease for each subsequent weld 302a-302c, until the hot-start increase is eliminated at the weld 302d.

In some other examples, the hot-start increase may be partially or completely implemented by modifying the spot timer 306 and/or the stitch timer 308. For example, the value of the spot timer 306 may be temporarily increased to increase the heat input for a predetermined number of the first welds 302 of the sequence, and/or the stitch timer 308 may be increased to reduce cooling between the welds 302 for a predetermined number of the first welds 302 of the sequence.

While the example of FIG. 3 illustrates the first three welds 302a-302c as having a hot-start power increase, more or fewer of the first welds 302a-302i may be controlled to have the hot-start power increase, and/or the number and/or duration of the hot-start power increase may be adjusted based on measuring the workpiece temperature. For example, as the temperature approaches a threshold and/or as the temperature gradient between welds 302a-302i decreases, the hot-start power increase may be reduced based on the temperature and/or the temperature gradient.

While the example spot timer 306 and stitch timer 308 start and end with respective events during the sequence of welds, in some examples the events associated with the starts and/or ends of the spot timer 306 and/or the stitch timer 308 may be modified. For example, the run-in periods 310 may be initialized prior to an end of the stitch timer 308 to cause the end of the stitch timer 308 to coincide with the end of the run-in period 310, and/or the stitch timer 308 may begin at an end of the spot timer 306 to perform the post-weld periods 312 while the stitch timer 308 is running.

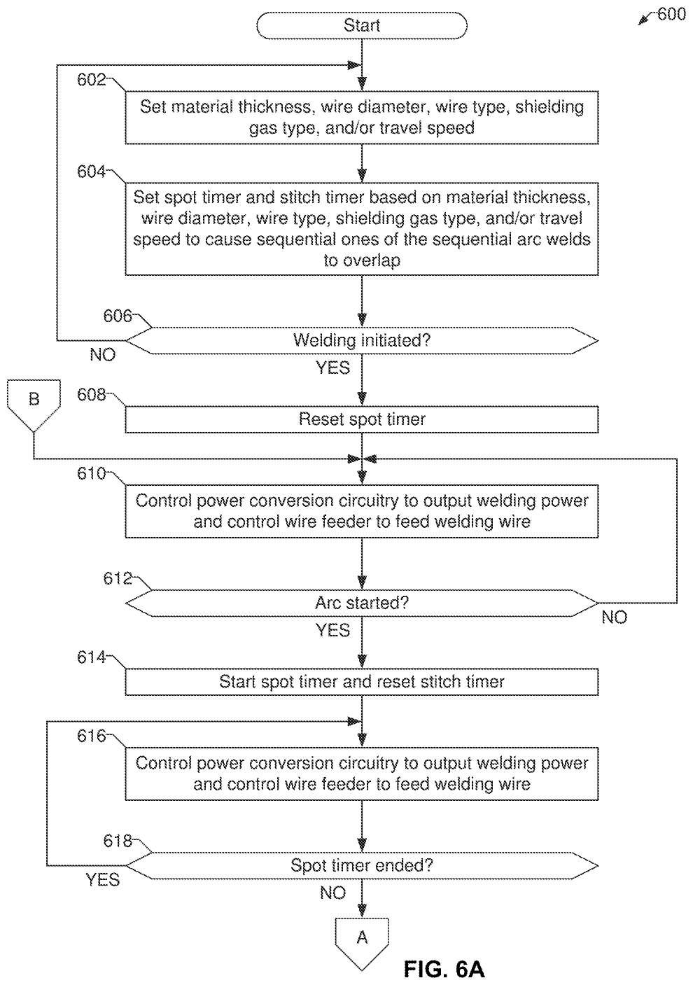

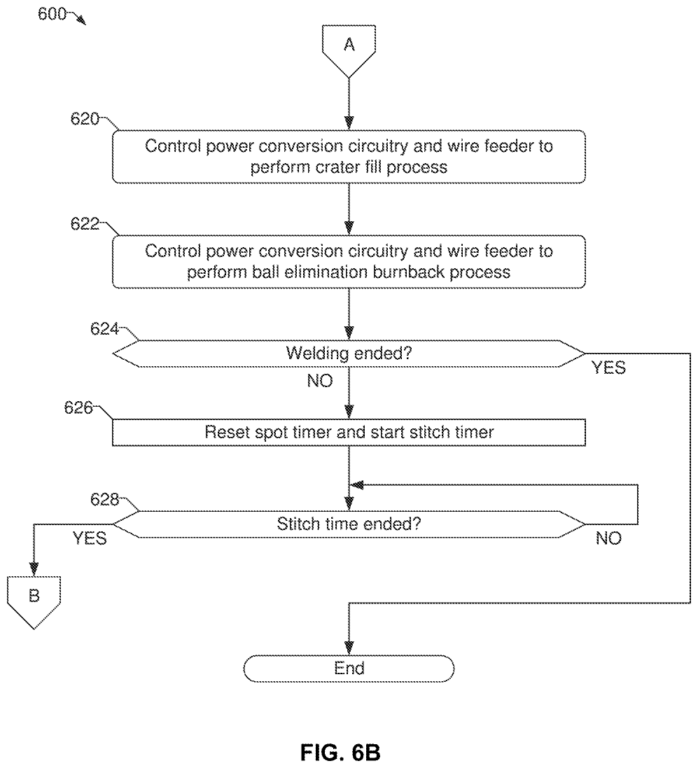

FIGS. 6A and 6B are a flowchart representative of example machine readable instructions 600 which may be executed by the control circuitry 112 of FIGS. 1 and/or 2 to control a welding process including sequential overlapping welds. The example instructions 600 are disclosed below with reference to the example system 100 of FIG. 1 and the processes illustrated in FIGS. 3-5.

At block 602, the control circuitry 112 sets a material thickness, a wire diameter, a wire type, a shielding gas type, and/or a travel speed. For example, the control circuitry 112 may receive one or more parameters via the user interface 114, from a remote interface via the communications transceiver 118, and/or using sensors (e.g., workpiece thickness sensors, wire type detectors, gas type detectors, travel speed sensors, etc.) coupled to the power supply 102 and/or the wire feeder 104.

At block 604, the control circuitry 112 sets a spot timer 306 and a stitch timer 308 based on the material thickness, the wire diameter, the wire type, the shielding gas type, and/or the travel speed, such that welding according to the spot timer 306 and the stitch timer 308 result in sequential ones of the sequential arc welds to overlap. For example, the spot timer 306 is set to time a welding duration for each of the sequential arc welds, and the stitch timer 308 is set to time a duration between the sequential arc welds. The control circuitry 112 determines respective starting values for each of the spot timer 306 and the stitch timer 308.

The control circuitry 112 may determine the travel speed based on an expected travel speed for a continuous weld having the same characteristics. In some examples, the control circuitry 112 further monitors the travel speed (e.g., using a travel speed sensor) and updates the values of the spot timer 306 and/or the stitch timer 308 to provide an acceptable heat input. The example control circuitry 112 may further set welding parameters such as welding wire feed speed, the arc voltage, a run-in wire feed speed 406, a starting wire speed 410, a post-weld target voltage 422, a crater fill wire speed threshold 418, and/or other parameters.

At block 606, the control circuitry 112 determines whether welding has been initiated. For example, the control circuitry 112 may determine whether a trigger signal has been received (e.g., from the torch 106, from the wire feeder 104). If welding has not been initiated (block 606), control returns to block 602 to continue configuring the welding parameters.

When welding has been initiated (block 606), at block 608 the control circuitry 112 resets the spot timer 306 (e.g., to the determined value in block 604) and, at block 610, the control circuitry 112 controls the power conversion circuitry 110 output the welding power and controls the wire feeder 104 to feed the welding wire. For example, the control circuitry 112 may implement the run-in period 310a to increase the wire feed speed prior to the arc.

At block 612, the control circuitry 112 determines whether an arc has started. For example, the control circuitry 112 may detect an output voltage and/or an output current to determine whether an arc is present. If an arc has not yet started (block 612), control returns to block 610.

Once an arc has started (block 612), at block 614 the control circuitry 112 starts the spot timer 306 and resets the stitch timer 308 (e.g., to the determined start value) and, at block 616, controls the power conversion circuitry 110 output the welding power and controls the wire feeder 104 to feed the welding wire.

At block 618, the control circuitry 112 determines whether the spot timer 306 has ended. For example, the control circuitry 112 may determine whether the spot timer 306 has reached an end value, such as zero when counting down. If the spot timer 306 has not ended (block 618), control returns to block 616.

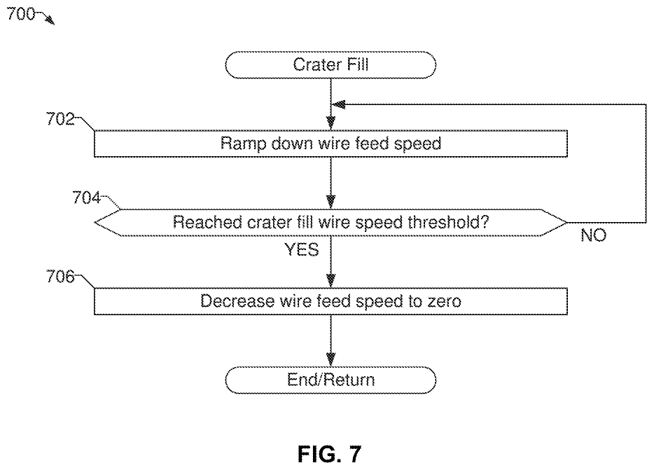

Turning to FIG. 6B, when the spot timer 306 ends (block 618), at block 620 the control circuitry 112 controls the power conversion circuitry 110 and the wire feeder to perform a crater fill process (e.g., the crater fill process 416 of FIG. 4). Example instructions to implement block 620 are disclosed below with reference to FIG. 7.

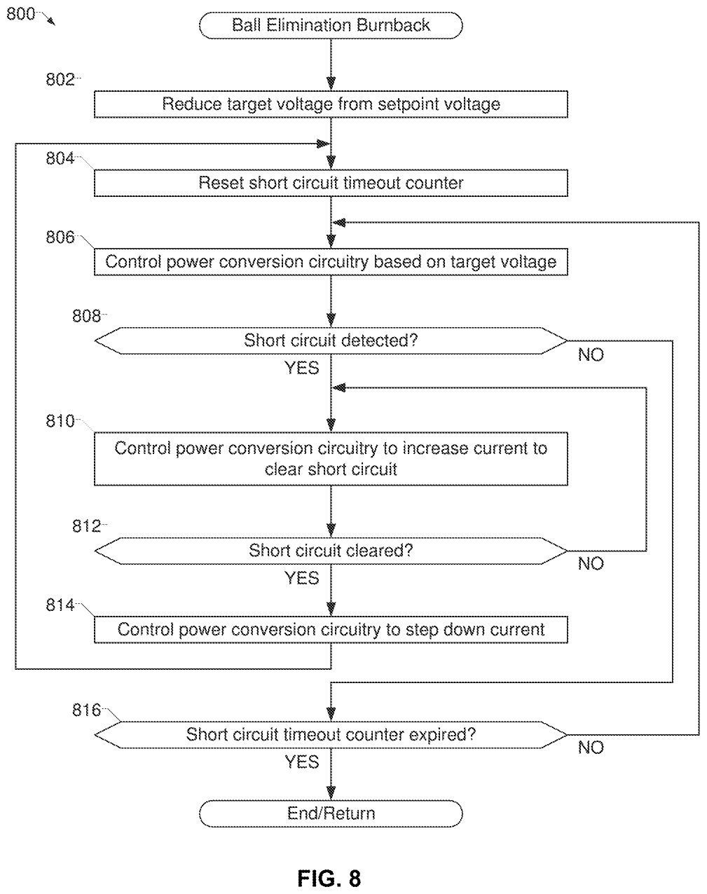

At block 622, the control circuitry 112 controls the power conversion circuitry 110 and the wire feeder to perform a ball elimination burnback process (e.g., the ball elimination burnback process 420 of FIG. 5). Example instructions to implement block 622 are disclosed below with reference to FIG. 8.

At block 624, the control circuitry 112 determines whether welding has ended. For example, the control circuitry 112 determines whether a trigger has been released or the sequence of welds is otherwise ended. If welding has ended (block 624), at block 626 the control circuitry 112 resets the spot timer 306 (e.g., to the determined starting value) and starts the stitch timer 308.

At block 628, the control circuitry 112 determines whether the stitch timer 308 has ended (e.g., reached an end value). If the stitch timer has not ended (block 628), control returns to block 628 to continue running the stitch timer 308. When the stitch timer 308 ends (block 628), control returns to block 610 (FIG. 6A).

When welding has ended (block 624), the example instructions 600 end.

FIG. 7 is flowchart representative of example machine readable instructions 700 which may be executed by the control circuitry 112 of FIGS. 1 and/or 2 to perform a crater fill process (e.g., the crater fill process 416 of FIG. 4). The instructions 700 may be executed to implement block 620 of FIG. 6B).

At block 702, the control circuitry 112 controls the wire feeder 104 to ramp down the wire feed speed 402 (e.g., from the welding wire speed 412). The reduction in wire speed also results in a decrease in output current.

At block 704, the control circuitry 112 determines whether the wire speed 402 has reached a crater fill wire speed threshold (e.g., the crater fill wire speed threshold 418). In some other examples, the control circuitry 112 may use a time threshold, a current threshold, a voltage threshold, and/or any other parameter to determine an end of the crater fill process 416. If the wire speed 402 has not reached the crater fill wire speed threshold 418 (block 704), control returns to block 702.

When the wire speed 402 has reached the crater fill wire speed threshold 418 (block 704), at block 706 the control circuitry 112 controls the wire feeder 104 to decrease the wire feed speed to zero (e.g., stop wire feeding to end the current weld 302). The example instructions 700 then end, and may return control to block 622 of FIG. 6B.

FIG. 8 is flowchart representative of example machine readable instructions 800 which may be executed by the control circuitry 112 of FIGS. 1 and/or 2 to perform a ball elimination burnback process (e.g., the ball elimination burnback process 420 of FIG. 5). The example instructions 800 may be executed to implement block 622 of FIG. 6B, and begin at an end of the crater fill process 416 of FIG. 4.

At block 802, the control circuitry 112 reduces a target output voltage from a setpoint voltage. For example, the control circuitry 112 may control the power conversion circuitry 110 to output a voltage (or a current based on a target voltage) that is insufficient to sustain an arc (e.g., below 10V). The reduced voltage reduces the likelihood of restriking an arc as the wire feed is stopped, but allows for clearing short circuits in the event of a short circuit occurring.

At block 804, the control circuitry 112 resets a short circuit timeout counter. The short circuit timeout counter may be set based on a duration indicative of an end of further short circuits for the most recent weld 302 that was just completed.

At block 806, the control circuitry 112 controls the power conversion circuitry 110 based on the target voltage. At block 808, the control circuitry 112 determines whether a short circuit is detected at the output (e.g., based on a detected voltage). For example, a short circuit may be detected if the output voltage is less than a short circuit threshold voltage.

If a short circuit is detected at the output (block 808), at block 810 the control circuitry 112 controls the power conversion circuitry 110 to increase the current 504 to clear the short circuit. For example, the power conversion circuitry 110 may increase the output current 504 to attempt to output the target output voltage.

At block 812, the control circuitry 112 determines whether the short circuit is cleared. For example, the control circuitry 112 may determine whether the output voltage 502 has increased above the short circuit threshold voltage. If the short circuit is not cleared (block 812), control returns to block 810 to continue increasing the current.

When the short circuit is determined to be cleared (block 812), at block 814 the control circuitry 112 controls the power conversion circuitry 110 to step down the output current 504. Control then returns to block 804 to reset the short circuit timer.

If a short circuit is not detected (block 808), at block 816 the control circuitry 112 determines whether the short circuit timeout counter has expired (e.g., reached an end value). If the short circuit timeout counter has not expired (block 816), control returns to block 806.

If the short circuit timeout counter has expired (block 816), the ball elimination burnback process 420 ends, the instructions 800 end, and control returns to block 624 of FIG. 6B.

The present methods and systems may be realized in hardware, software, and/or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may include a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein. As used herein, the term “non-transitory machine-readable medium” is defined to include all types of machine readable storage media and to exclude propagating signals.

As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present disclosure. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A welding power supply, comprising:
power conversion circuitry configured to convert input power to welding power; and
control circuitry configured to:
set a spot timer representative of an arc duration for a plurality of sequential arc welds;
set a stitch timer representative of a duration between sequential ones of the sequential arc welds; and
in response to initiation of welding, controlling the power conversion circuitry to perform the plurality of sequential arc welds by controlling the arc duration of each of the plurality of sequential arc welds based on the spot timer and controlling the duration between the sequential ones of the sequential arc welds based on the stitch timer, wherein the spot timer and the stitch timer are set to cause sequential ones of the sequential arc welds to overlap.

2. The welding power supply as defined in claim 1, wherein the spot timer is based on at least one of a material thickness input, a wire diameter input, a wire type input, or a shielding gas type input.

3. The welding power supply as defined in claim 1, wherein the stitch timer is based on at least one of a material thickness input, a wire diameter input, a wire type input, or a shielding gas type input.

4. The welding power supply as defined in claim 1, wherein the spot timer is less than 1 second.

5. The welding power supply as defined in claim 1, wherein the stitch timer is less than 2 seconds.

6. The welding power supply as defined in claim 1, wherein the control circuitry is configured to, following initiation of an arc, ramp at least one of a wire feed speed or a voltage from an initial value up to a setpoint value.

7. The welding power supply as defined in claim 1, wherein the control circuitry is configured to, following expiration of the spot timer, ramp down the wire feed speed for a predetermined crater fill time.

8. The welding power supply as defined in claim 1, wherein the control circuitry is configured to, in response to detecting a clearing of a short circuit, control the power conversion circuitry to step down the current.

9. The welding power supply as defined in claim 1, wherein the control circuitry is configured to, in response to detecting an end of an arc during the plurality of sequential welds:
control the power conversion circuitry to increase an output current until a short circuit clear is detected; and
in response to detecting the short circuit clear, control the power conversion circuitry to reduce the output current to less than a threshold current at at least a threshold ramp rate.

10. The welding power supply as defined in claim 1, wherein the control circuitry is configured to, in response to the initiation of welding:
for at least one of a predetermined number of the sequential welds or a predetermined time, increase an output power relative to an output power based on setpoints; and
decreasing the output power for each sequential one of the plurality of welds until reaching the output power based on the setpoints.

11. The welding power supply as defined in claim 1, further comprising a user interface configured to receive at least one of a material thickness input, a wire diameter input, a wire type input, or a shielding gas type input, and comprising an input configured to turn the spot timer and the stitch timer on or off.

12. The welding power supply as defined in claim 11, wherein the user interface is configured to receive an input modifying a travel speed, the control circuitry configured to set at least one of the spot timer or the stitch timer based on the modified travel speed.

13. The welding power supply as defined in claim 11, wherein the user interface is configured to receive at least one of an input to modify the spot timer or an input to modify the stitch timer.

14. The welding power supply as defined in claim 11, wherein the control circuitry is configured to, in response to the input turning on the at least one of the spot timer or the stitch timer, modify at least one of a parameter to increase the heat input or a control loop response rate.

15. The welding power supply as defined in claim 1, wherein the control circuitry is configured to continue controlling the power conversion circuitry to perform the plurality of sequential welds while a welding torch trigger remains actuated.

16. The welding power supply as defined in claim 1, wherein at least one of the spot timer or the stitch timer are based on a travel speed input.

17. The welding power supply as defined in claim 1, wherein at least one of the spot timer or the stitch timer are based on a same travel speed as a continuous weld for a same material thickness, a same wire diameter, a same wire type, and a same shielding gas type input.

18. The welding power supply as defined in claim 1, further comprising a weld position sensor configured to determine a travel speed of a welding torch, the control circuitry configured to set at least one of the spot timer or the stitch timer based on the determined travel speed.

19. The welding power supply as defined in claim 1, wherein at least one of the spot timer or the travel timer are fixed for the entirety of the plurality of sequential welds.

20. The welding power supply as defined in claim 1, wherein at least one of the spot timer or the stitch timer are ramped over a predetermined number of the sequential welds following the initiation of welding.

21. A welding power supply, comprising:
power conversion circuitry configured to convert input power to welding power;
weld torch positioning sensor configured to determine a position of the weld torch; and
control circuitry configured to:
set a spot timer representative of an arc duration for a plurality of sequential arc welds; and
in response to initiation of welding, controlling the power conversion circuitry to perform the plurality of sequential arc welds by:
controlling a beginning of each of the sequential arc welds based on the position of the weld torch; and
controlling the arc duration of each of the plurality of sequential arc welds based on the spot timer.
